(19) United States
(12) Patent Application Publication
(10) Pub. No.: US 2004/0184114 A1
(43) Pub. Date: Sep. 23, 2004

(54) Flatbed scanner and scan module thereof

(76) Inventor: Hsi-Yu Chen, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/447,720

(22) Filed: May 29, 2003

(30) Foreign Application Priority Data
Mar. 21, 2003 (TW) 092106248

(51) Int. Cl. H04N 1/04

(52) U.S. Cl. 358/474; 358/494

(57) ABSTRACT

A flatbed scanner includes a driving motor, a belt connected to the driving motor and driven by the driving motor to move, and a carriage module. The carriage module is transmitted by the belt to move and has an elastic sustaining member arranged on a housing thereof for sustaining against the belt. By distorting the belt, the tension of the belt is increased.

### FIELD OF THE INVENTION

The present invention relates to a scanner, and more particularly to a flatbed scanner. In addition, the present invention also relates to a scan module of a flatbed scanner.

### BACKGROUND OF THE INVENTION

Please refer to FIG. 1 which is a schematic diagram showing an internal structure of a conventional flatbed scanner. As shown, the flatbed scanner includes a shaft 1, a driving motor 10, a belt 11 and a carriage module 12 accommodated in a housing 2. When the flatbed scanner is operating, the driving motor 10 drives the belt 11 to carry the carriage module 12 to move along the shaft 1. Hence, the belt 11 must have a certain tension.

For easily assembling, various conventional structures, for example that as shown in FIG. 2A or 2B, are provided to enhance the tension of the belt 11. In the structure of FIG. 2A, a flexible metal strip 13 is coupled to the belt 11. On the other hand, a torsion spring 14 is engaged with the belt 11 in the structure of FIG. 2B.

Due to the demand to reduce the thickness and size of scanner products, the space in current flatbed scanners is quite limited. Thus, during scanning, the carriage module 12 is likely to contact with the protruding part 131 or 141 of the metal strip 13 or torsion spring 14 so as to influence the scanning operation of the carriage module 12.

Therefore, the purpose of the present invention is to enhance the tension of the belt without interfering with the carriage module.

### SUMMARY OF THE INVENTION

An object of the present invention is to provide a scan module having a belt-tension enhanced mechanism secured thereon so as not to interfere with the scan module.

Another object of the present invention is to provide a flatbed scanner which includes a belt-tension enhanced mechanism secured onto a scan module thereof so as not to interfere with the scan module.

A first aspect of the present invention relates to a flatbed scanner, which comprises a driving motor; a belt connected to the driving motor and driven by the driving motor to move; and a carriage module transmitted by the belt to move, and having an elastic sustaining member arranged on a housing thereof for sustaining against the belt to increase the tension of the belt.

Preferably, the elastic sustaining member is integrally formed with the housing of the carriage module.

Preferably, the elastic sustaining member includes a flexible strip made of plastic and integrally formed with the housing of the carriage module.

Preferably, the elastic sustaining member includes a base portion secured onto the housing of the carriage module; a belt-holder portion configured to confine the movement of the belt; and a sustaining portion sustaining against the belt to distort a portion of the belt so as to increase the tension of the belt.

Preferably, the belt-holder portion includes a hollow portion for penetrating therethrough and securing therein the portion of the belt.

Preferably, the sustaining portion has a smooth hooked end.

Preferably, the carriage module further comprises a sustaining post arranged on the housing, and cooperating with the sustaining portion of the elastic sustaining member to distort the portion of the belt by sustaining against the belt at a side opposite to the elastic sustaining member.

Preferably, the carriage module further comprises a clamping member arranged on the housing for penetrating therethrough and securing therein another portion of the belt.

A second aspect of the present invention relates to a scan module for use in an image processing device, the image processing device including a driving motor and a belt for moving the scan module, the scan module including an elastic sustaining member arranged on a housing thereof for sustaining against the belt to increase the tension of the belt.

Preferably, the elastic sustaining member is integrally formed with the housing of the scan module, and includes a base portion secured onto a housing of the carriage module; a belt-holder portion configured to confine the movement of the belt; and a sustaining portion sustaining against the belt to distort a portion the belt so as to increase the intension of the belt.

Preferably, the belt-holder portion includes a hollow member for penetrating therethrough and securing therein the portion of the belt.

Preferably, the sustaining portion sustains against the belt by a smooth hooked end.

Preferably, the carriage module further comprises a sustaining post arranged on the housing for sustaining against the belt at a side opposite to the elastic sustaining member.

Preferably, the carriage module further comprises a clamping member arranged on the housing for penetrating therethrough and securing therein another portion of the belt.

In an example, the scan module is a carriage module and the image processing device is a flatbed scanner.

In another example, the scan module is a print-head module and the image processing device is a printer.

### BRIEF DESCRIPTION OF THE DRAWINGS

The present invention may best be understood through the following description with reference to the accompanying drawings, in which:

FIG. 1 is a schematic diagram showing an internal structure of a conventional flatbed scanner;

FIGS. 2A and 2B are schematic diagrams illustrating two conventional structures for increasing the tension of the belt in the flatbed scanner; and

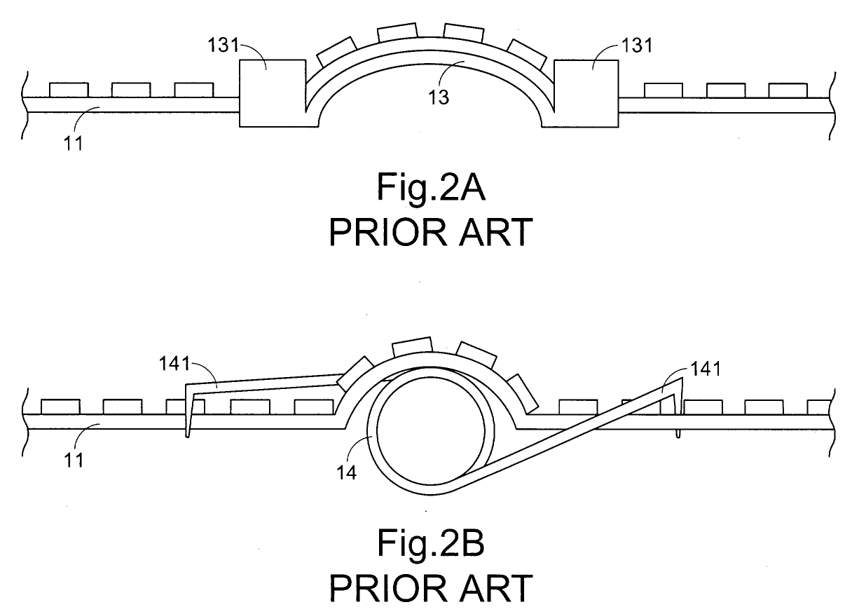

FIG. 3 is a schematic diagram illustrating a part of housing structure of a preferred embodiment of a scan module according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

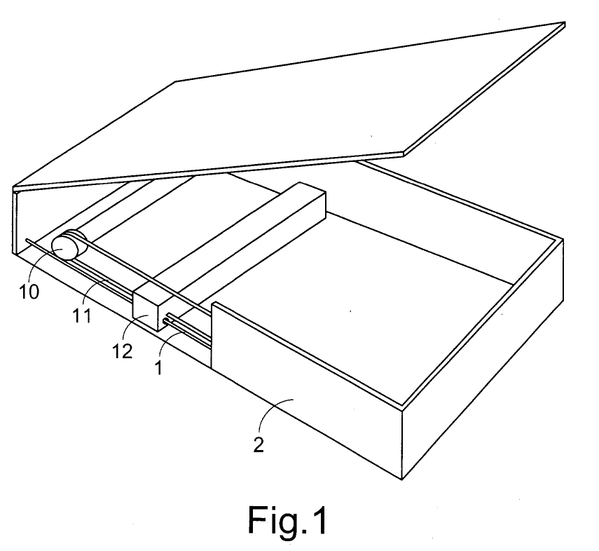

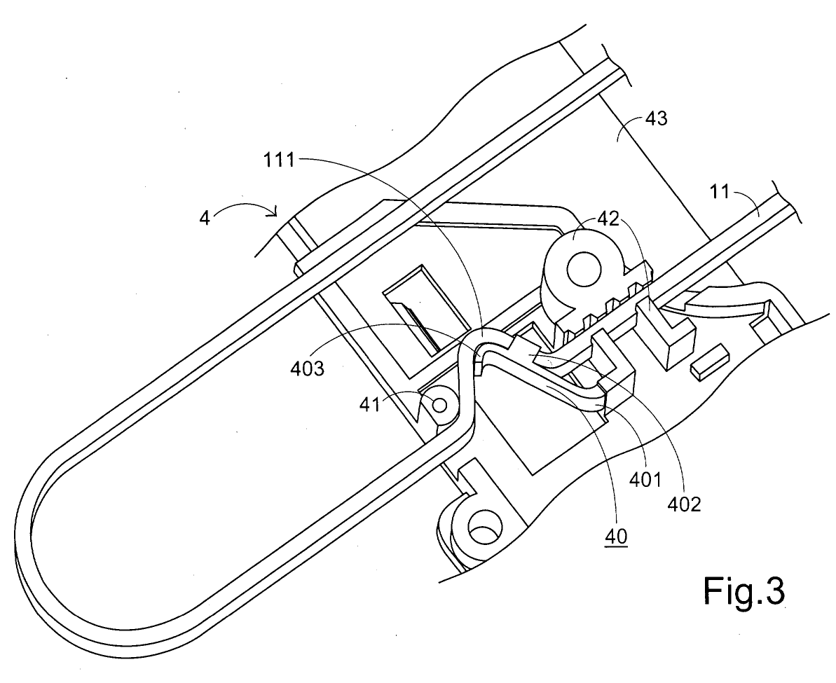

Please refer to FIG. 3 which is a schematic diagram partially illustrating a preferred embodiment of a scan module according to the present invention. For example, the scan module can be used in a flatbed scanner similar to that shown in FIG. 1. The flatbed scanner includes a shaft 1, a driving motor 10, a belt 11 and the present scan module 4, which operate as mentioned above. The scan module 4 includes a plastic strip 40, a sustaining post 41 and a clamping member 42, which are arranged on a housing 43 of the scan module 4. The plastic strip 40 includes a base portion 401, a belt-holder portion 402 and a sustaining portion 403 in contact with the belt 11. The base portion 401 is secured onto the housing 43. The sustaining portion 403 has a smooth hooked end sustaining against the belt 11, and the sustaining post 41 sustaining against the belt at a side opposite to the sustaining portion 403. By the cooperation of the sustaining portion 403 and the sustaining post 41, a portion 111 of the belt 11 is distorted, and thus the tension of the belt 11 is enhanced. The belt-holder portion 402 is a hollow member for allowing the belt 42 to penetrate through and securing the portion 111 of the belt 11 therein. In addition to the belt-holder portion 402, the clamping portion 42 also facilitates to receive and secure the belt 11. It is not necessary but preferred that the plastic strip 40, sustaining post 41 and clamping member 42 be arranged on an inner surface of the housing 43 and integrally formed with the housing 43 in order to reduce assembling cost.

It is apparent from the above description, the tension of the belt can be enhanced by this mechanism secured on the module housing without interfering with the carriage module. In addition, the manufacturing and assembling procedures can be simplified because the flexible metal strip or the torsion spring of the prior art is no longer required in the present invention.

The belt-tension enhanced mechanism according to the present invention can also be applied to other scan modules such as a print-head module of an ink jet printer, which is also moved by a driving motor and a belt. The function and structure of the belt-tension enhanced mechanism are similar to those applied to the flatbed scanner in FIG. 3. Thus, it is not to be described redundantly herein.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A flatbed scanner comprising:
a driving motor;
a belt connected to said driving motor and driven by said driving motor to move; and
a carriage module transmitted by said belt to move, and having an elastic sustaining member arranged on a housing thereof for sustaining against said belt to increase the tension of said belt.

2. The flatbed scanner according to claim 1 wherein said elastic sustaining member is integrally formed with said housing of said carriage module.

3. The flatbed scanner according to claim 1 wherein said elastic sustaining member includes a flexible strip.

4. The flatbed scanner according to claim 3 wherein said flexible strip is made of plastic.

5. The flatbed scanner according to claim 4 wherein said flexible strip is integrally formed with said housing of said carriage module.

6. The flatbed scanner according to claim 1 wherein said elastic sustaining member includes:
a base portion secured onto said housing of said carriage module;
a belt-holder portion configured to confine the movement of said belt; and
a sustaining portion sustaining against said belt to distort a portion of said belt so as to increase the tension of said belt.

7. The flatbed scanner according to claim 6 wherein said belt-holder portion includes a hollow portion for penetrating therethrough and securing therein said portion of said belt.

8. The flatbed scanner according to claim 6 wherein said sustaining portion has a smooth hooked end.

9. The flatbed scanner according to claim 6 wherein said carriage module further comprises a sustaining post arranged on said housing, and cooperating with said sustaining portion of said elastic sustaining member to distort said portion of said belt by sustaining against said belt at a side opposite to said elastic sustaining member.

10. The flatbed scanner according to claim 6 wherein said carriage module further comprises a clamping member arranged on said housing for penetrating therethrough and securing therein another portion of said belt.

11. A scan module for use in an image processing device, said image processing device including a driving motor and a belt for moving said scan module, said scan module including an elastic sustaining member arranged on a housing thereof for sustaining against said belt to increase the tension of said belt.

12. The scan module according to claim 11 wherein said elastic sustaining member is integrally formed with said housing of said scan module.

13. The scan module according to claim 11 wherein said elastic sustaining member is a plastic strip.

14. The scan module according to claim 11 wherein said elastic sustaining member includes:
a base portion secured onto a housing of said carriage module;
a belt-holder portion configured to confine the movement of said belt; and
a sustaining portion sustaining against said belt to distort a portion said belt so as to increase the intension of said belt.

15. The scan module according to claim 14 wherein said belt-holder portion includes a hollow member for penetrating therethrough and securing therein said portion of said belt.

16. The scan module according to claim 14 wherein said sustaining portion sustains against said belt by a smooth hooked end.

17. The scan module according to claim 11 wherein said carriage module further comprises a sustaining post arranged on said housing for sustaining against said belt at a side opposite to said elastic sustaining member.

18. The scan module according to claim 111 wherein said carriage module further comprises a clamping member arranged on said housing for penetrating therethrough and securing therein another portion of said belt.

19. The scan module according to claim 11 wherein said scan module is a carriage module and said image processing device is a flatbed scanner.

20. The scan module according to claim 11 wherein said scan module is a print-head module and said image processing device is a printer.
